(19) United States
(12) Patent Application Publication
(10) Pub. No.: US 2003/0207103 A1
(43) Pub. Date: Nov. 6, 2003

(54) System and method for protecting surfaces against corrosive compounds

(76) Inventors: Charles M. Zvosec, Elmherst, OH (US); Efim Ya Lyublinski, Solon, OH (US)

Correspondence Address: Joseph J. Crimaldi, Renner, Otto, Boisselle & Sklar, LLP, Nineteenth Floor, 1621 Euclid Avenue, Cleveland, OH, 44115, US

(21) Appl. No.: 10/139,045

(22) Filed: May 3, 2002

(51) Int. Cl. B32B 5/16

(52) U.S. Cl. 428/329; 428/332; 138/140

(57) ABSTRACT

The present invention relates to a system and method for protecting and/or coating surfaces such as the surfaces of pipes, flues and/or conduits against corrosive environments which may be contained within or outside of the pipe, flue and/or conduit. More particularly, in one embodiment the present invention relates to a pipe, flue and/or conduit which has been coated with two or more layers which act to improve the corrosion resistance of the metal pipe, flue and/or conduit.

### FIELD OF THE INVENTION

The present invention relates to a system and method for protecting and/or coating surfaces such as the surfaces of pipes, flues and conduits against corrosive and/or abrasive environments which may be contained within or outside items such as pipes, flues and/or conduits. More particularly, in one embodiment the present invention relates to a pipe, flue and/or conduit which has been coated with two or more layers which act to improve the corrosion and/or abrasion resistance of the metal pipe, flue and/or conduit.

### BACKGROUND OF THE INVENTION

This invention relates to multi-layered coatings which are capable of imparting improved corrosion resistance surfaces such as the surfaces, be they interior or exterior, of pipes, flues and/or conduits.

A combination of factors have changed the conditions under which pipes, flues and/or conduits in many industrial locations, such as power plants and smelters, are operated. These changed factors have made the problem of corrosion, particularly acid corrosion, more critical. For example, any number of processes generate one or more exhaust gases which contain compounds which are corrosive to one or more surfaces of a metal pipe, flue and/or conduit under certain environmental conditions. The interior temperatures in these pipes, flues or conduits can range from ambient (i.e., the temperature outside the exterior surface of the pipe, flue or conduit) to about 300° C. In some cases, temperature spikes occur inside such pipes, flues or conduits. In these cases, the temperature within the pipe, flue or conduit may rise up to about 600° C.

For example, high temperature refining processes can create large amounts of exhaust gases which contain therein high concentrations of SOₓ gases. When the temperature of the gases inside the pipe, flue or conduit is close to or at the dew point of the corresponding acid, corrosion of the interior surface of the pipe, flue and/or conduit occurs readily due to the condensation of and/or the reaction of the SOₓ gases with water thereby yielding acidic compounds. Additionally, other gases such as water, carbon dioxide, nitrogen and NOₓ can become corrosive when exposed to the interior environment of a pipe, flue or conduit.

Due to this corrosion, it is necessary to frequently inspect and when applicable, patch any holes which may have formed in the pipe, flue or conduit. Depending upon the amount of corrosive materials expelled through the pipe, flue and/or conduit, it eventually becomes necessary to totally replace the pipe, flue and/or conduit with a new piece of metal piping. This is necessary because the patches on the old pipe, flue or conduit become too numerous and can have a detrimental effect on the structural integrity of the pipe, flue or conduit.

One major drawback of repairing or replacement of corroded exhaust pipes, flues or conduits is that the processes which are generating the exhaust gases must be shut down so that the repair work can be completed to the pipe, flue or conduit. This results in a decrease in production capacity. In a nickel smelting operation, for example, an average plant loses up to $1,000,000 per day when the plant is idle for exhaust pipe repair.

In view of the above, a system which would impart improved corrosion resistance to existing pipes, flues and/or conduits and which could be installed without the need for shutting down the operations being conducted at the plant in question would be desirable. Also desirable would be a system which could impart improved corrosion resistance to either one of both of the exterior and interior surfaces of new pipes, flues or conduits. If placed on the inside of a new pipe, flue or conduit, such a system could also impart improved abrasion resistance.

Given the fact that it may not be possible to access the interior of existing pipes, flues and conduits, such a system should, at a minimum, contain externally mounted components which could be applied to existing pipes, flues and conduits in order to increase their resistance to corrosive environments. In the case of new pipes, flues and 5 conduits, a system which uses either all externally, all internally or a combination of externally and internally mounted components would be useful.

Also of use would be an externally mounted system which could offer protection to existing and/or new pipes, flues or conduits even if the underlying pipe, flue or conduit completely disintegrates.

### SUMMARY OF THE INVENTION

In accordance with one embodiment, the present invention relates to a system for coating a surface such as a pipe, flue and/or conduit comprising: (a) an insulating layer having a first surface and a second surface, the first surface being the surface which contacts the surface to be coated; (b) an aggregate layer formed on the second surface of the insulating layer, the aggregate layer having a first surface which is in contact with the insulating layer and a second surface, the aggregate layer comprising at least one ceramic compound and at least one filler material; and (c) a polymer layer formed on the second surface of the aggregate layer, the polymer layer having a first surface which is in contact with the aggregate layer and a second surface.

In another embodiment, the present invention relates to a system for coating a surface such as a pipe, flue and/or conduit comprising: (a) a ceramic layer having a first surface and a second surface, the first surface being the surface which contacts the surface to be coated; (b) an insulating layer formed on the second surface of the ceramic layer, the insulating layer having a first surface which is in contact with the ceramic layer and a second surface; (c) an aggregate layer formed on the second surface of the insulating layer, the aggregate layer having a first surface which is in contact with the insulating layer and a second surface, the aggregate layer comprising at least one ceramic compound and at least one filler material; and (d) a polymer layer formed on the second surface of the aggregate layer, the polymer layer having a first surface which is in contact with the aggregate layer and a second surface.

In another embodiment, the present invention relates to a coated article resistant to corrosion or deterioration comprising: (a) a substrate having an interior surface and an exterior surface; (b) an insulating layer formed on the exterior surface of the substrate, the insulating layer having a first surface which is in contact with the exterior surface of the substrate and a second surface; (c) an aggregate layer formed on the second surface of the insulating layer, the aggregate layer having a first surface which is in contact with the insulating layer and a second surface, the aggregate layer comprising at least one ceramic compound and at least one filler material; and (d) a polymer layer formed on the second surface of the aggregate layer, the polymer layer having a first surface which is in contact with the aggregate layer and a second surface.

In yet another embodiment, the present invention relates to a coated article resistant to corrosion or deterioration comprising: (a) a substrate having an interior surface and an exterior surface; (b) a ceramic layer formed on the exterior surface of the substrate, the ceramic layer having a first surface which is in contact with the exterior surface of the substrate and a second surface; (c) an insulating layer formed on the second surface of the ceramic layer, the insulating layer having a first surface which is in contact with the ceramic layer and a second surface; (d) an aggregate layer formed on the second surface of the insulating layer, the aggregate layer having a first surface which is in contact with the insulating layer and a second surface, the aggregate layer comprising at least one ceramic compound and at least one filler material; and (e) a polymer layer formed on the second surface of the aggregate layer, the polymer layer having a first surface which is in contact with the aggregate layer and a second surface.

In yet another embodiment, the present invention relates to a method for protecting a surface such as a pipe, flue or conduit against corrosion and/or abrasion comprising the steps of: (1) applying an insulating layer to at least one surface of the surface to be protected, the insulating layer having a first surface which is in contact with the at least one surface of the surface to be protected and a second surface; (2) applying an aggregate layer to the second surface of the insulating layer, the aggregate layer having a first surface which is in contact with the insulating layer and a second surface, the aggregate layer comprising at least one ceramic compound and at least one filler material; and (3) applying a polymer layer to the second surface of the aggregate layer, the polymer layer having a first surface which is in contact with the aggregate layer and a second surface.

In yet another embodiment, the present invention relates to a method for protecting a surface such as a pipe, flue or conduit against corrosion and/or abrasion comprising the steps of: (1) applying a ceramic layer to at least one surface of the surface to be protected, the ceramic layer having a first surface which is in contact with the at least one surface of the surface to be protected and a second surface; (2) applying an insulating layer to the second surface of the ceramic layer, the insulating layer having a first surface which is in contact with the ceramic layer and a second surface; (3) applying an aggregate layer to the second surface of the insulating layer, the aggregate layer having a first surface which is in contact with the insulating layer and a second surface, the aggregate layer comprising at least one ceramic compound and at least one filler material; and (4) applying a polymer layer to the second surface of the aggregate layer, the polymer layer having a first surface which is in contact with the aggregate layer and a second surface.

In yet another embodiment, the present invention relates to a system for coating a surface such as a pipe, flue or conduit, comprising: (a) at least one inner polymer layer, each inner polymer layer having a first surface and a second surface, the first surface being the surface which contacts or faces the surface to be coated; (b) a metal shell, the metal shell having a first surface which is in contact with the second surface of the at least one inner polymer layer and a second surface; (c) an insulating layer formed on the second surface of the metal shell, the insulating layer having a first surface which is in contact with the second surface of the metal shell and a second surface; and (d) an outer polymer layer formed on the second surface of the insulating layer, the outer polymer layer having a first surface which is in contact with the insulating layer and a second surface.

In yet another embodiment, the present invention relates to a system for coating a surface such as a pipe, flue or conduit, comprising: (a) a first polymer layer, the first polymer layer having a first surface and a second surface, the first surface being the surface which is in contact with the surface to be coated; (b) a second polymer layer, the second polymer layer having a first surface which is in contact with the second surface of the first polymer layer and a second surface, the second polymer layer being impregnated with reinforcing fibers; (c) an insulating layer formed on the second surface of the second polymer layer, the insulating layer having a first surface which is in contact with the second surface of the second polymer layer and a second surface; and (d) a polymer layer formed on the second surface of the insulating layer, the polymer layer having a first surface which is in contact with the insulating layer and a second surface.

In yet another embodiment, the present invention relates to a system for coating the interior surface such as the interior surface of a pipe, flue or conduit, comprising: (a) a ceramic layer having a first surface and a second surface, the first surface being the surface which contacts the interior surface of the pipe, flue or conduit; (b) a polymer layer formed on the second surface of the ceramic layer, the polymer layer having a first surface which is in contact with the ceramic layer and a second surface; and (c) an aggregate layer formed on the second surface of the polymer layer, the aggregate layer having a first surface which is in contact with the polymer layer and a second surface, the aggregate layer comprising at least one ceramic compound and at least one filler material.

To the accomplishment of the foregoing and related ends, the invention, then, comprises the features hereinafter fully described and particularly pointed out in the claims. These embodiments are indicative, however, of but a few of the various ways in which the principles of the invention may be employed. Other objects, advantages and features of the invention will become apparent from the following detailed description of the invention.

### BRIEF DESCRIPTION OF THE DRAWINGS

FIG. 1 is a cross-sectional view of one embodiment according to the present invention;

FIG. 2 is a cross-sectional view of another embodiment according to the present invention;

FIGS. 3A and 3B are cross-section views of another embodiment according to the present invention;

FIG. 4 is a cross-section view of another embodiment according to the present invention;

FIG. 5 is a cross-section view of another embodiment according to the present invention;

FIG. 6 is a cross-section view of another embodiment according to the present invention;

FIG. 7 is a cross-section view of another embodiment according to the present invention; and

FIG. 8 is a cross-section view of another embodiment according to the present invention.

### DETAILED DESCRIPTION OF THE INVENTION

As noted above, the present invention relates to a system and method for protecting surfaces such as pipes, flues and/or conduits against corrosive and/or abrasive environments which may be contained within or outside such pipes, flues and/or conduits. More particularly, in one embodiment the present invention relates to a pipe, flue or conduit which has been coated with two or more layers which act to improve the corrosion and/or abrasion resistance of the metal pipe, flue or conduit.

In another embodiment, the present invention permits the service life of metal pipes, flues and/or conduits to be extended even if the original metal pipe, flue and/or conduit completely disintegrates.

Additionally, it should be noted that in the following text, where utilized, range and ratio limits may be combined.

Surfaces:

In one embodiment, the present invention relates to a system which imparts improved corrosion and/or abrasion resistance to one or more surfaces (or substrates) such as pipes, flues or conduits. The material from which the surface is made from is not of particular importance so long as the surface is susceptible to corrosion and/or abrasion from one or more corrosive/abrasive compounds present in the environment surrounding the surface to be protected. Examples of corrosive compounds include, but are not limited to, water, carbon dioxide, nitrogen, oxygen, NOₓ, SOₓ, Cl⁻, Cl₂ and F₂. Examples of abrasive compounds include, but are not limited to, soot, dust, numerous types of ash and particulate matter. Examples of metals which are used to form pipes, flues and conduits which are susceptible to corrosion from corrosive compounds include, but are not limited to, copper, carbon steel, steel, stainless steel (regardless of type or grade), aluminum, bronze, tin, iron, and alloys thereof. In another embodiment, the underlying substrate to be protected can be made of brick or concrete.

As noted above, the present invention may be applied to either the interior or exterior of a pipe, flue or conduit.

Protective System Embodiments:

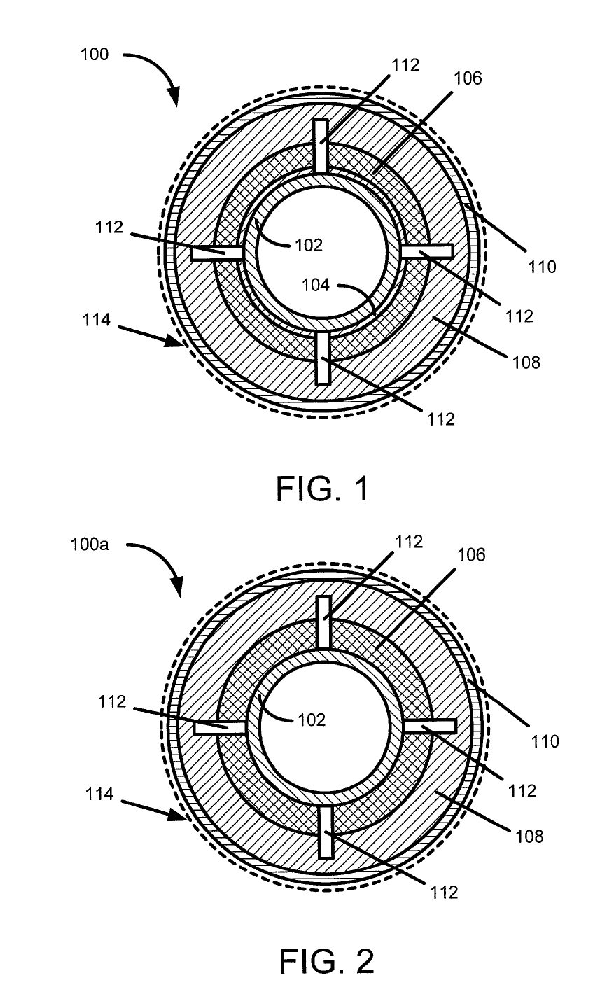

Turning now to the figures, FIG. 1 illustrates one embodiment of the present invention. In the protective system 100 of FIG. 1, a surface such as a pipe, flue or conduit 102 to be protected is shown in a cross-sectional view (hereinafter the surface to be protected/coated will be referred to as only pipe 102). The pipe 102 can be any shape (i.e., the pipe 102 does not have to be round), size or length, and can be formed from any suitable material, as is discussed above. The only requirement of the pipe 102 is that it is susceptible to corrosion and/or abrasion from one or more corrosive and/or abrasive compounds which exist in either one or both of the exterior and interior environments to the pipe 102. In the embodiment of FIG. 1, the protective system 100 comprises a ceramic layer 104, an insulating layer 106, an aggregate layer 108, and a polymer layer 110.

In another embodiment, the protective system 100 can optionally include support anchors 112, which are shown in FIG. 1. If present, the support anchors 112 are formed so as to extend through layers 104 and 106, and partially through layer 108.

In one embodiment, ceramic layer 104 is formed from a ceramic refractory coating. Examples of such coatings include, but are not limited to, aluminum oxide, magnesium oxide, chromium oxide, silicon monoxide, silicon dioxide, titanium dioxide, metal and non-metal nitrides, borides and carbides, and mixtures of two or more thereof. In one embodiment, the compound utilized for the ceramic layer 104 is suitable for thermal spray application to the exterior of the pipe 102 where the external surface of the pipe 102 has a temperature in the range of about 70° C. to about 110° C., or from about 75° C. to about 105° C., or even from about 80° C. to about 100° C.

Depending upon the type and/or amount of surface preparation conducted on the pipe 102, a mechanical bond may be formed between the exterior surface of pipe 102 and ceramic layer 104.

In another embodiment, where a chemical bond between the pipe 102 and the ceramic layer 104 is required and/or desired, any suitable application technique and ceramic coating material can be used to form ceramic layer 104. Such techniques include, but are not limited to, applying the ceramic layer 104 as a solution or dispersion in any conventional manner including rolling, brushing, troweling, air-atomized spraying, airless spraying, dipping or painting. With regard to the above-mentioned additional application techniques, these application techniques do not preclude the generation of a chemical bond between ceramic layer 104 and pipe 102. Rather, once pipe 102 has been coated with the desired ceramic layer 104, pipe 102 can be subjected to further processing to produce a chemical bond between pipe 102 and ceramic layer 104 by, for example, high temperature curing at a temperature of at least about 500° C. for at least about 1 hour. One of skill in the art would recognize that given the composition of ceramic layer 104, the temperature and time for curing this layer will vary depending upon the exact composition of layer 104. Choosing the curing time/temperature parameters for ceramic layer 104 in order to yield a bond with the underlying pipe 102 is within the skill of someone of ordinary skill in the art and as such a discussion of how to choose these parameters is omitted herein.

In one embodiment, ceramic layer 104 has a thickness of from about 2 mils to about 10 mils, or from about 3 mils to about 8 mils, or even from about 4 mils to about 6 mils. It should be noted that in most cases the thickness of ceramic layer 104 will not be uniform. As such, in the various embodiments discussed above ceramic layer 104 is formed to have a minimum thickness and maximum thickness which falls within the stated ranges. It should be noted that no matter what the thickness of the ceramic layer 104, the material utilized to form layer 104 should be applied by a suitable technique so as to yield a layer that has a porosity of less than about 1.5%, or less than about 1%, or even less than about 0.5%.

With regard to insulating layer 106, in one embodiment layer 106 is formed from a suitable insulating material that can withstand maximum surface temperatures up to about 850° C., or up to about 750° C., or even up to about 650° C. Suitable insulating materials include, but are not limited to, aluminum silicates, ceramic insulating blankets, materials made of wool fibers from basalt rock and steel slag (e.g., ROXUL® available from Roxul, Inc., Ontario Canada) or a combination of two or more thereof. The compound from which insulating layer 106 is formed is selected so that the insulating layer 106 has a density in the range of about 4 lbs/ft³ (64 kg/m³) to about 9 lbs/ft³ (144 kg/m³), or in the range of about 4.25 lbs/ft³ (68.1 kg/m³) to about 8 lbs/ft³ (128 kg/m³), or even about 4.4 lbs/ft³ (70 kg/m³) to about 7.5 lbs/ft³ (120 kg/m³). Insulating layer 106 can be any suitable thickness so long as the exterior surface temperature of insulating layer 106 is less than 65° C., or even less than 60° C., after application of the insulating layer 106 to ceramic layer 104 and pipe 102.

In one embodiment, insulating layer 106 has a thickness of from about 0.25 inches to about 5 inches, or from about 0.5 inches to about 3.5 inches, or even from about 1 inch to about 2 inches. It should be noted that in most cases the thickness of insulating layer 106 will not be uniform as different portions of pipe 102 may require more or less insulation in order to ensure a minimum continuous operating temperature is maintained within the interior of pipe 102. As such, in the various embodiments discussed above insulating layer 106 is formed to have a minimum thickness and maximum thickness which falls within the stated ranges. For example, in one embodiment insulating layer 106 is formed from a suitable combination of one and two inch thick layer of ROXUL® which is applied in any suitable manner around the exterior of pipe 102 after the application of ceramic layer 104 is complete.

With regard to aggregate layer 108, in one embodiment layer 108 is formed from a suitable aggregate material made from a mixture of at least one ceramic material such as aluminum oxide, aluminum silicates, potassium silicates, metal and non-metal nitrides, borides and carbides, or mixtures of two or more thereof with at least one filler material such as water glass (e.g., Na₂O:SiO₂), concrete, foamed concrete, or mixtures thereof.

The ceramic portion of the material used to form aggregate layer 108 is selected so as to be resistant to one or more acids which may attack the pipe 102 from either the exterior or interior. Such acids include, but are not limited to, sulfuric, nitric, hydrochloric, hydrochloric and hydrofluoric. One suitable compound which can be used to form aggregate layer 108 is an acid proof concrete (available from Sauereisen of Pittsburgh, Pa. under the designation number of 54 or 54 LW).

In one embodiment, aggregate layer 108 has an initial thickness of about 0.75 inches to about 6 inches, or about 1.25 inches to about 4.5 inches, or even about 1.75 inches to about 4 inches. Once aggregate layer 108 has cured for a given period (e.g., from about 12 to about 36 hours, or from about 15 to 33 hours, or even from about 18 to about 30 hours), some shrinkage may or may not occur. Aggregate layer 108 is applied using any suitable technique. Such techniques include, but are not limited to, troweling, spraying, spray painting or guniting.

With regard to polymer layer 110, in one embodiment layer 110 is formed from any polymer which is water-proof and weather resistant. Such polymers include, but are not limited to, fluoropolymers and epoxy-phenolic polymer compositions. Suitable fluoropolymers include, but are not limited to, tetrafluoroethylene/hexafluoropropylene copolymer (FEP), tetrafluoroethylene-perfluoroalkylvinylether copolymer (TFA/PFA), and HYFLON® MFA fluoropolymer, HYFLON® PFA (perfluoroalkoxy), TEFLON® PFA, polyurethanes (e.g., Urethane CP2010 from Aremco Products, Inc.), epoxy phenolic resins (e.g., Epoxy-Phenolic CP 2050 from Aremco Products, Inc), PYTON® PPS (polyphenylene sulfide) and mixtures thereof. Also of use is CAAPCOAT Type III or Type IV rain and thermal resistant fluoroelastomer available from the CAAP Company.

Polymer layer 110 can be applied by any suitable technique. Such techniques include, but are not limited to, rolling, brushing, air-atomized spraying, airless spraying, or painting.

In one embodiment, multiple individual sub-layers formed from two or more of the above-mentioned polymers can be utilized to form polymer layer 110. In this embodiment, polymer layer 110 may not be a single layer rather layer 110 may be a layer which contains multiple distinct or slightly blended sub-layers.

In one embodiment, polymer layer 110 is formed to have a thickness of about 1 mil to about 10 mils, or from about 1.5 mils to about 8 mils, or even from about 2 mils to about 4 mils.

Although depicted in FIG. 1, protective system 100 can, if desirable and/or necessary, further include support anchors 112 which can be of any shape or size and are formed of steel or a steel alloy to lend support to the protective system 100. Additionally, support anchors 112 also act to offset the effects of any changes in the coefficients of thermal expansion in layers 104, 106 and 108.

Such anchors are especially useful when the pipe 102 to be protected is operated within a temperature range which causes physical changes in the structure of pipe 102 and/or protective system 100. If present, support anchors 112 can be placed in any suitable pattern. For example, support anchors 112 could be placed at regular intervals from one another on the surface of pipe 102. In one embodiment, support anchors 112 are pin shaped. In another embodiment, support anchors 112 can be a grid or scaffolding setup which is formed so as to encompass the exterior of pipe 102 and is attached to or connected via any suitable means to pipe 102.

The exact length which support anchors 112 extend from the outer surface of pipe 102 depends in part upon how much support is desired for protective system 100. In one embodiment, support anchors 112 are formed so as to extend at least 50 percent of the way through aggregate layer 108 once the aggregate layer 108 is in place. In another embodiment, support anchors 112 are formed to extend at least 75 percent of the way through aggregate layer 108 once the aggregate layer 108 is in place.

Depending upon the exact nature of the material used to form support anchors 112, they can be affixed to pipe 102 in any suitable manner. For example, support anchors 112 can be connected via welding, adhesive means (e.g., glue, epoxy, resin, etc.) and/or mechanical means (e.g., riveted, bolted on, screwed on, etc.).

As depicted in FIG. 1 by the dashed circle 114, protective system 100 can optionally include a retaining member 114 formed from stainless steel mesh/screen or stainless steel mesh tape which is wrapped around the exterior surface of polymer layer 110. Stainless steel is useful in this application because it is corrosion resistant. However, the present invention is not limited thereto. In fact, any suitable mesh/screen or mesh tape can be utilized so long as the compound from which the mesh/screen or tape is formed is both corrosion and acid resistant.

Turning to FIG. 2, FIG. 2 depicts a protective system 100a which is substantially identical to that of FIG. 1 except that the ceramic layer 104 has been eliminated. As such, a detailed discussion of this embodiment is omitted.

The embodiment of FIG. 2 is useful in situations where the material utilized to form insulating layer 106 is non-reactive with the material from which pipe 102 is composed.

In another embodiment, depending upon the surface temperature of the surface (e.g., pipe 102) to be protected, insulating layers 106 of protective systems 100 and 100a of FIGS. 1 and 2 may need to be selected so as to be heat resistant up to a temperature of at least about 200° C., or at least about 250° C., or at least about 300° C., or at least about 400° C., or at least about 500° C., or even at least about 600° C. This is advantageous where the surface to be protected is prone to temperature spikes above common operating ranges. It should be noted that with regard to any of the embodiments disclosed herein, such a heat resistant insulating layer could optionally be used rather than an insulating layer designed only to function within the normal operating temperature range of the surface to be protected.

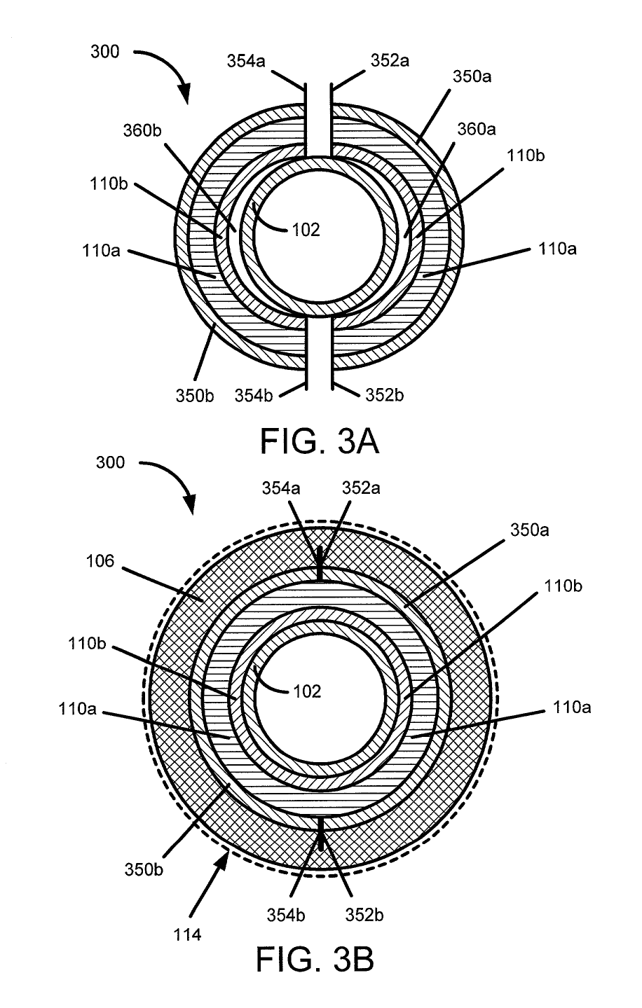

In the embodiment of FIGS. 3A and 3B, like reference numerals to those utilized in the embodiments of FIG. 1 and 2 are indicative of layers composed of and formed by the materials and methods discussed above with reference to the embodiments of FIG. 1 and 2 and the further discussion hereof is omitted for brevity.

Turning to FIGS. 3A and 3B, FIGS. 3A and 3B depict a protective system 300 which is similar to that discussed above with regard to the embodiments of FIGS. 1 and 2. However, the embodiment of FIGS. 3A and 3B differs from the previously described embodiments in that the layers are applied in reverse order to one or more appropriately shaped shells 350a and 350b made of a corrosion resistant material. As shown in FIG. 3A, two semi-circular shells 350a and 350b can be used to protect a round pipe by applying shells 350a and 350b over the outer surface of the pipe 102 to be protected and connecting them to one another via any suitable means such as flanges 352a, 352b, 354a and 354b. As the shells 350a and 350b are brought together and joined, spaces 360a and 360b are eliminated.

The shells 350a and 350b can be made of any suitable material (e.g., steel, aluminum, stainless steel, or alloys thereof) and can be connected via any suitable connection means. Such means include, but are not limited to, welding, rivets, screws, bolts, clamps, adhesive or epoxy. Alternatively, shells 350a and 350b need not have flanges, but could be joined by any suitable means including, but not limited to, clamps, adhesive, epoxy, welding, and mechanical means (such as wrapping brackets or belts around pipe 102 at desired intervals).

In one embodiment, shells 350a and 350b have a thickness of between about 0.015 inches and 0.25 inches, or about 0.025 inches to about 0.15 inches, or even about 0.03 inches to about 0.1 inches.

Again, the discussion regarding this embodiment references only circular pipe 102. However, this embodiment is applicable to any shape pipe, flue or conduit. Such shapes include, but are not limited to, circular, elliptical, square, trapezoidal, rectangular, polygonal or triangular. In one embodiment, the system of FIGS. 3A and 3B is useful for protecting newly manufactured pipes, flues or conduits.

Alternatively, this embodiment can also be utilized to protect pipes, flues or conduits that have generally uniform dimensions. That is, the pipe, flue or conduit must have a minimum variation in surface smoothness. For example, in one embodiment at least about 75 percent, or at least about 80 percent, or even at least about 85 percent, of the surface of the pipe, flue or conduit to be protected should have a surface variation of less than about 0.2 inches, or less than about 0.15 inches, or even less than about 0.1 inches. That is, for example, at least 75 percent of the surface of the pipe 102 should have a low point no lower than more than about 0.15 inches lower than the highest point on the surface of the pipe 102.

As shown in FIGS. 3A and 3B, protective system 300 differs from the embodiments of FIGS. 1 and 2 in that the order of and existence of the layers contained in protective system 300 differ. Initially, a polymer layer 110a is applied to the inner surface of metal shells 350a and 350b, in one embodiment layer 110a is formed from any polymer which is acid-proof and resistant to temperatures of at least about 200° C., or at least about 250° C., or at least about 300° C., or at least about 400° C., or at least about 500° C., or even at least about 600° C. Such polymers include, but are not limited to, fluoropolymers and epoxy-phenolic polymer compositions. Suitable fluoropolymers include, but are not limited to, tetrafluoroethylene/hexafluoropropylene copolymer (FEP), tetrafluoroethylene-perfluoroalkylvinylether copolymer (TFA/PFA), and HYFLON® MFA fluoropolymer, HYFLON® PFA (perfluoroalkoxy), TEFLON® PFA, polyurethanes (e.g., Urethane CP2010 from Aremco Products, Inc.), epoxy phenolic resins (e.g., Epoxy-Phenolic CP 2050 from Aremco Products, Inc), PYTON® PPS (polyphenylene sulfide) and mixtures thereof. Also of use is CAAPCOAT Type III or Type IV rain and thermal resistant fluoroelastomer available from the CAAP Company.

Polymer layer 110a can be applied by any suitable technique. Such techniques include, but are not limited to, rolling, brushing, air-atomized spraying, airless spraying, or painting.

In one embodiment, multiple individual sub-layers formed from two or more of the above-mentioned polymers can be utilized to form polymer layer 110a. In this embodiment, polymer layer 110a may not be a single layer rather layer 110a may be a layer which contains multiple distinct or slightly blended sub-layers.

In one embodiment, polymer layer 110a is formed to have a thickness of about 3 mil to about 30 mils, or from about 4.5 mils to about 24 mils, or even from about 6 mils to about 14 mils.

After the formation of polymer layer 110a is complete polymer layer 110b is formed on the inner surface of polymer layer 110a. It is polymer layer 110b which acts as a primer layer against pipe 102 so as to ensure airtightness. In one embodiment, layer 110b is formed from any polymer which is also acid-proof and resistant to temperatures up to at least about 250° C., or even up to at least about 300° C. Such polymers include, but are not limited to, fluoropolymers and epoxy-phenolic polymer compositions. Suitable fluoropolymers include, but are not limited to, tetrafluoroethylene/hexafluoropropylene copolymer (FEP), tetrafluoroethylene-perfluoroalkylvinylether copolymer (TFA/PFA), and HYFLON® MFA fluoropolymer, HYFLON® PFA (perfluoroalkoxy), TEFLON® PFA, polyurethanes (e.g., Urethane CP2010 from Aremco Products, Inc.), epoxy phenolic resins (e.g., Epoxy-Phenolic CP 2050 from Aremco Products, Inc), PYTON® PPS (polyphenylene sulfide) and mixtures thereof. Also of use are high temperature polymer particulates, for example, polyamide particulates as disclosed in U.S. Pat. No. 6,124,000, which is incorporated herein in its entirety by reference.

Polymer layer 110b can be applied by any suitable technique. Such techniques include, but are not limited to, rolling, brushing, air-atomized spraying, airless spraying, or painting.

In one embodiment, multiple individual sub-layers formed from two or more of the above-mentioned polymers can be utilized to form polymer layer 110b. In this embodiment, polymer layer 110b may not be a single layer rather layer 110b may be a layer which contains multiple distinct or slightly blended sub-layers.

In one embodiment, polymer layer 110b is formed to have a thickness of about 1 mil to about 10 mils, or from about 1.5 mils to about 8 mils, or even from about 2 mils to about 4 mils.

Once the application of polymer layers 110a and 110b are completed, the two semi-circular sub-portions of protective system 300 are brought together around the exterior surface of pipe 102 (see FIG. 3A) and joined together using any suitable method as discussed above (see FIG. 3B). It should be noted that the embodiment of FIGS. 3A and 3B permits the formation of the metal shell/polymer layer combination to be conducted off-site. That is, installation of the initial portion of protective system 300 need not be conducted at the site of the pipe 102 to be protected.

Once the metal shells 350a and 350b have been joined, an insulating layer 106 and a retaining member 114 are applied over the exterior surfaces of metal shells 350a and 350b. Optionally, protective system 300 can further include support anchors 112 (not shown) which have been attached to the exterior surface metal shells 350a and 350b in any desired pattern. The composition of and method of attaching such support anchors 112 is discussed above with regard to the embodiments of FIGS. 1 and 2 and is omitted here.

As noted above, the nature and manner of application of insulating layer 106 and a retaining member 114 is identical in nature to layers 106 and 114 of the embodiments of FIGS. 1 and 2. As such, a further discussion of these layers here is omitted.

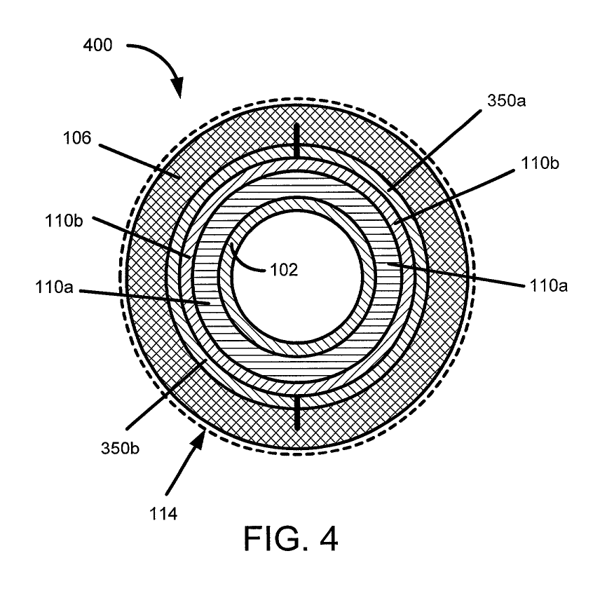

Turning to FIG. 4, protective system 400 is identical in nature to the embodiment of FIGS. 3A and 3B except for the fact that polymer layers 110a and 110b are reversed. That is, polymer layer 110b is applied to the interior surfaces of metal shells 350a and 350b and then polymer layer 110a is applied over the interior surface of polymer layer 110b. Due to the similarities between the embodiment of FIG. 4 and that of FIGS. 3A and 3B, a further discussion hereof of the embodiment of FIG. 4 is omitted for brevity.

In another embodiment, the protective system 400 of FIG. 4 can be formed by first applying polymer layer 110a to the surface of pipe 102 using any suitable technique such as, but are not limited to, rolling, brushing, air-atomized spraying, airless spraying, or painting. Depending upon the surface temperature of pipe 102, polymer layer 110a may need to be composed of a polymer which can be applied at a temperature of at least about 80° C., or even at least about 100 C., without foaming or running off of the exterior surface of pipe 102. Accordingly, in this embodiment, the composition of polymer layer 110a may differ from that discussed above with regard to the embodiment of FIGS. 3A and 3B. Polymers which fit the above criteria are known to those of skill in the art and a discussion hereof is omitted.

After polymer layer 110a has cured, polymer layer 110b is applied over polymer layer 110a. Depending upon the surface temperature of the exterior surface of polymer layer 110a, the composition of polymer layer 110b may be the same or different than the identically numbered layer of the embodiment of FIGS. 3A and 3B. Again, one of ordinary skill in the art would readily recognize the polymer composition needed to form polymer layer 110b without foaming or run-off given the surface temperature of polymer layer 110a. After the application of polymer layer 110b is complete, metal shells 350a and 350b are placed around pipe 102 and polymer layers 110a and 110b and joined accordingly as described above.

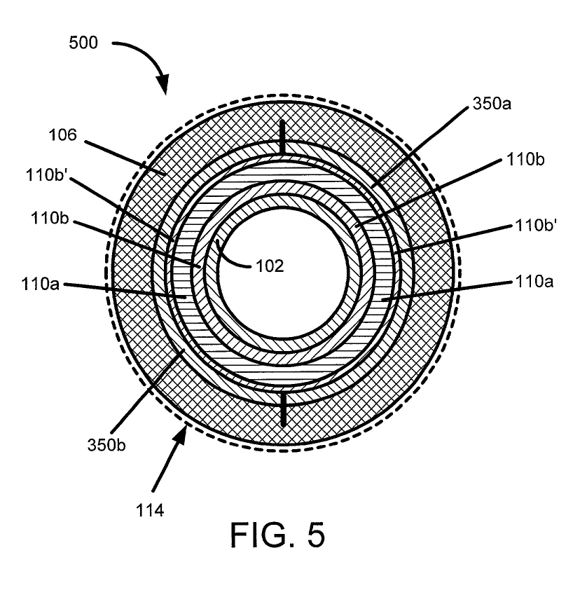

Turning to FIG. 5, protective system 500 is identical in nature to the embodiment of FIGS. 3A and 3B except for the fact that an additional polymer layer 110b′ is applied over the interior surfaces of metal shells 350a and 350b prior to the application of polymer layer 110a. Polymer layer 110a is then applied over the interior surface of polymer layer 110b′, and finally polymer layer 110b is applied over the interior surface of polymer layer 110a. In this embodiment, polymer layers 110b and 110b′ can be identical or different from one another. Additionally, polymer layers 110b and 110b′ need not be the same thickness so long as the thickness of each layer falls within the ranges stated for polymer layer 110b of the embodiment of FIGS. 3A and 3B. Due to the similarities between the remaining portions of the embodiment of FIG. 5 and that of FIGS. 3A and 3B, a further discussion hereof of the embodiment of FIG. 5 is omitted for brevity.

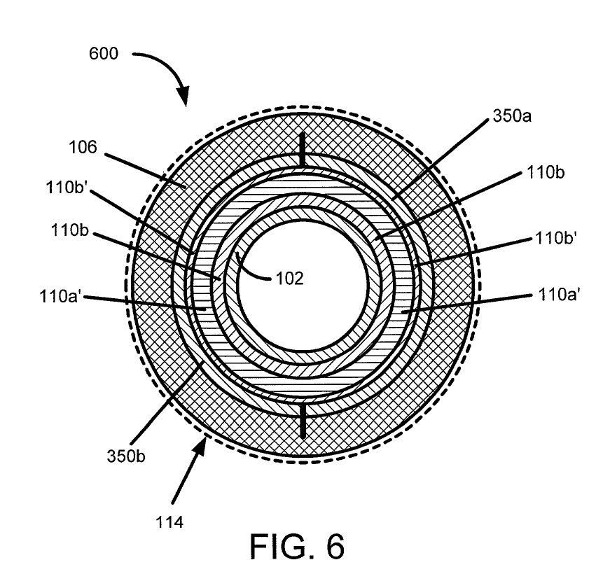

Turning to FIG. 6, protective system 600 is identical in nature to the embodiment of FIG. 5 except for the fact that polymer layer 110a°′, which is otherwise identical to polymer layer 110a of the embodiment of FIG. 5, is impregnated with suitable reinforcing fibers (e.g., fibreglass fibers, carbon fibers, ceramic fibers, basalt fibers, etc.) to give layer 110a′ further strength and weatherability. Due to the similarities between the remaining portions of the embodiment of FIG. 6 and that of FIG. 5, a further discussion hereof of the embodiment of FIG. 6 is omitted for brevity.

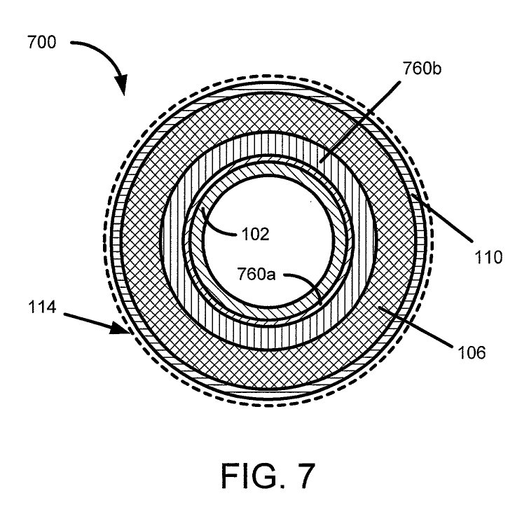

Turning to FIG. 7, protective system 700 contains a polymer layer 760a formed on the exterior surface of pipe 102. In one embodiment layer 760a is formed from any polymer which is also acid-proof and resistant to heat up to temperatures of at least about 200° C., or at least about 250° C., or at least about 300° C., or at least about 400° C., or at least about 500° C., or even at least about 600° C. Such polymers include, but are not limited to, fluoropolymers and epoxy-phenolic polymer compositions. Suitable fluoropolymers include, but are not limited to, tetrafluoroethylene/hexafluoropropylene copolymer (FEP), tetrafluoroethylene-perfluoroalkylvinylether copolymer (TFA/PFA), and HYFLON® MFA fluoropolymer, HYFLON® PFA (perfluoroalkoxy), TEFLON® PFA, polyurethanes (e.g., Urethane CP2010 from Aremco Products, Inc.), epoxy phenolic resins (e.g., Epoxy-Phenolic CP 2050 from Aremco Products, Inc), PYTON® PPS (polyphenylene sulfide) and mixtures thereof. Also of use are high temperature polymer particulates, for example, polyamide particulates as disclosed in U.S. Pat. No. 6,124,000, which is incorporated herein in its entirety by reference.

Polymer layer 760a can be applied by any suitable technique. Such techniques include, but are not limited to, rolling, brushing, air-atomized spraying, airless spraying, or painting.

In one embodiment, multiple individual sub-layers formed from two or more of the above-mentioned polymers can be utilized to form polymer layer 760a. In this embodiment, polymer layer 760a may not be a single layer rather layer 760a may be a layer which contains multiple distinct or slightly blended sub-layers.

In one embodiment, polymer layer 760a is formed to have a thickness of about 1 mil to about 10 mils, or from about 1.5 mils to about 8 mils, or even from about 2 mils to about 4 mils.

Next, a polymer layer 760b, which is impregnated with any suitable fiber as discussed above with regard to the embodiment of FIG. 6, is formed over the exterior surface of polymer layer 760a. The polymer portion of layer 760b is formed from any suitable polymer which includes, but is not limited to, fluoropolymers and epoxy-phenolic polymer compositions. Suitable fluoropolymers include, but are not limited to, tetrafluoroethylene/hexafluoropropylene copolymer (FEP), tetrafluoroethylene-perfluoroalkylvinylether copolymer (TFA/PFA), and HYFLON® MFA fluoropolymer, HYFLON® PFA (perfluoroalkoxy), TEFLON® PFA, polyurethanes (e.g., Urethane CP2010 from Aremco Products, Inc.), epoxy phenolic resins (e.g., Epoxy-Phenolic CP 2050 from Aremco Products, Inc), PYTON® PPS (polyphenylene sulfide) and mixtures thereof. Also of use are high temperature polymer particulates, for example, polyamide particulates as disclosed in U.S. Pat. No. 6,124,000, which is incorporated herein in its entirety by reference.

In one embodiment, polymer layer 760b has an initial thickness of about 2 mils to about 40 mils, or about 5 mils to about 30 mils, or even about 10 mils to about 20 mils. Polymer layer 760b can be applied by any suitable technique. Such techniques include, but are not limited to, rolling, brushing, air-atomized spraying, airless spraying, or painting.

In one embodiment, multiple individual sub-layers formed from two or more of the above-mentioned polymers can be utilized to form polymer layer 760b. In this embodiment, polymer layer 760b may not be a single layer rather it may be a layer which contains multiple distinct or slightly blended sub-layers.

Next an insulating layer 106 is applied over polymer layer 760b and then a polymer layer 110 is applied over insulating layer 106. The insulating layer 106 and polymer layer 110 are identical in nature to the insulating and polymer layers of the embodiment of a FIG. 1. As such, a further discussion thereof is omitted.

With regard to the embodiments of FIGS. 4, 5, 6 and 7, it should be noted that any one or all of the protective systems disclosed in these Figures can optionally include support anchors 112 (not shown) which have been attached to the exterior surface metal shells 350a and 350b (for the embodiments of FIGS. 4, 5 and 6) and to the exterior surface of pipe 102 (for the embodiment of FIG. 7) in any desired pattern. The composition of and method of attaching such support anchors are discussed above with regard to the embodiments of FIGS. 1 and 2 and as such a discussion hereof is omitted.

Additionally, although not shown in the Figures, the protective systems of FIGS. 4, 5 and 6 can optionally further include a polymer layer 110 (as described above with regard FIG. 1, but not shown in FIGS. 4, 5 and 6) which is formed on the outer surface of insulating layer 106. For the embodiment of FIG. 4, this polymer layer 110 is formed prior to the application of retaining member 114. The protective systems of FIGS. 5, 6, and 7 can also optionally include a retaining member 114 as discussed above with regard to the embodiments of FIGS. 1 and 2.

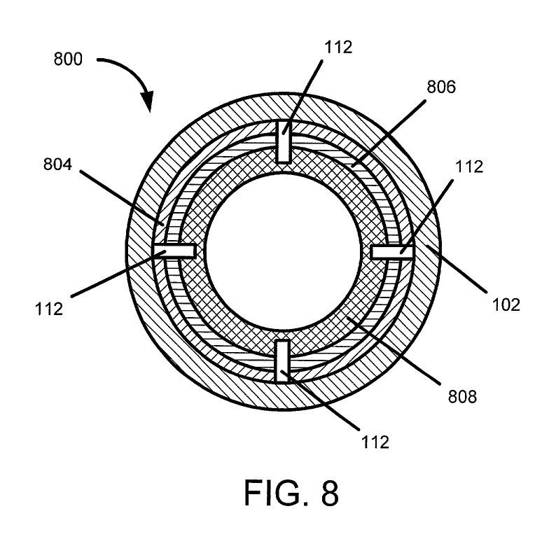

Turning to FIG. 8, protective system 800 is formed on the interior surface to be protected of pipe 102. Protective system 800 includes a ceramic layer 804 formed on the interior surface of pipe 102. The composition and application of ceramic layer 804 is identical in nature to that of ceramic layer 104 of the embodiment of FIG. 1. As such, a further discussion hereof is omitted.

Next, a polymer layer 806 is deposited over the interior surface of ceramic layer 804. The composition and application of polymer layer 806 is identical in nature to that of polymer layer 110b of the embodiment of FIGS. 3A and 3B. As such, a further discussion hereof is omitted.

Then, an aggregate layer 808 is applied over the interior surface of polymer layer 806. The composition and application of aggregate layer 808 is identical in nature to that of aggregate layer 108 of the embodiment of FIG. 1. As such, a further discussion hereof is omitted.

With regard to the embodiment of FIG. 8, it should be noted that this protective system 800 can optionally include support anchors 112 which have been attached to the interior surface of pipe 102 in any desired pattern. The composition of and method of attaching such support anchors 112 are discussed above with regard to the embodiments of FIGS. 1 and 2 and as such a discussion hereof is omitted. In this embodiment, if present, support anchors 112 are formed so as to extend at least about 50 percent of the way through layers 804, 806 and 808, or at least about 75 percent of the way through layers 804, 806 and 808, or even at least about 90 percent of the through layers 804, 806 and 808.

Although not limited thereto, protective system 800 is useful for new pipes, flues and conduits where it is possible to access the interior of such pipes, flues and conduits prior to their installation in an industrial plant, etc.

Exemplary Method for Applying a Protective System to a Pipe:

Suitable methods for applying the protective systems of the present invention to pipes, flues or conduits will be discussed below. As noted above, the discussion relating to the methods of applying the systems of the present invention will refer to pipes, flues and conduits generically as pipes.

With regard to the embodiment of FIG. 1, initially, depending upon the condition of the pipe 102 to be protected, it may be necessary to clean either one or both of the surfaces of the pipe 102 via sand blasting and/or the application of corrosion removing and/or inhibiting compositions. Techniques for accomplishing these tasks are well known in the art and a discussion herein is omitted.

Next the pipe 102 is inspected to ascertain whether any cracks, holes or other defects exist in pipe 102. Such inspection can be done via the naked eye, using ultrasound, or any other suitable pipe inspection technique as known in the art. If desirable, any or all of the defects are repaired using suitable techniques to patch such defects. These techniques, which are known in the art, are selected given the exact nature of the material from which pipe 102 is formed. Techniques which are useful in repairing pipes include, but are not limited to, welding, adhesives, patching, and caulking.

Next, if present, one or more support anchors 112 are attached via a suitable means, as is discussed above, to pipe 102 so as to protrude at a desired level above the surface of pipe 102. As noted above previously, support anchors 112, if present, act to offset the effects of any changes in the coefficients of thermal expansion in layers 104, 106 and 108 for the embodiment of FIG. 1, and layers 106 and 108 for the embodiment of FIG. 2.

Next, if present, the ceramic layer 104 is applied at a desired thickness using a suitable technique as is discussed above. Then, insulating layer 106 is either applied over layer 104 once layer 104 is dry, or insulating layer 106 is applied over the exterior of pipe 102 at a desired thickness using a suitable technique as is discussed above.

Next, aggregate layer 108 is applied over the surface of insulating layer 106 at a desired thickness using a suitable technique as is discussed above, and then polymer layer 110 is applied over the surface of aggregate layer 108 at desired thickness using a suitable technique as is discussed above. Finally, if desired, a suitable retaining member 114 can be applied over the exterior surface of polymer layer 110.

With regard to the embodiments of FIGS. 2, 3A/3B, 4, 5, 6 and 7, a detailed discussion of the application process is omitted for brevity in view of the information contained above regarding the application processes and parameters for each of the layers contained in the embodiments of FIGS. 2, 3A/3B, 4, 5, 6 and 7.

With regard to the embodiment of FIG. 8, initially, depending upon the condition of the pipe 102 to be protected, it may be necessary to clean either one or both of the surfaces of the pipe 102 via sand blasting and/or the application of corrosion removing and/or inhibiting compositions. Techniques for accomplishing these tasks are well known in the art and a discussion herein is omitted.

Next the pipe 102 is inspected to ascertain whether any cracks, holes or other defects exist in pipe 102. Such inspection can be done via the naked eye, using ultrasound, or any other suitable pipe inspection technique as known in the art. If desirable, any or all of the defects are repaired using suitable techniques to patch such defects. These techniques, which are known in the art, are selected given the exact nature of the material from which pipe 102 is formed. Techniques which are useful in repairing pipes include, but are not limited to, welding, adhesives, patching, and caulking.

Next, ceramic layer 804 is applied at a desired thickness using a suitable technique as is discussed above to the interior surface of pipe 102. Then, polymer layer 806 is applied over the interior surface of the ceramic layer 804 using a suitable technique as is discussed above.

Next, aggregate layer 808 is applied over the interior surface of polymer layer 806 at a desired thickness using a suitable technique as is discussed above. After the installation of protective system 800 is completed, pipe 102 can be installed where needed.

If present, one or more support anchors 112 are prior to the application of ceramic layer 804 via a suitable means, as is discussed above, so as to extend into the interior of the pipe 102 as discussed above. Support anchors 112, if present, act to offset the effects of any changes in the coefficients of thermal expansion in layers 804, 806 and 808.

It should be noted that with regard to all of the embodiments disclosed within the Figures of the present application, the relationship of the size (i.e., thickness) of the layers to the thickness and size of pipe 102 have been exaggerated for ease of viewing.

Although the present invention has been shown and described with respect to certain embodiments, it is obvious that equivalent alterations and modifications will occur to others skilled in the art upon the reading and understanding of this specification. In particular with regard to the various functions performed by the above described components, the terms (including any reference to a “means”) used to describe such components are intended to correspond, unless otherwise indicated, to any component which performs the specified function of the described component (e.g., that is functionally equivalent) even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

What is claimed is:

1. A system for coating a surface comprising:
(a) an insulating layer having a first surface and a second surface, the first surface being the surface which contacts the surface to be coated;
(b) an aggregate layer formed on the second surface of the insulating layer, the aggregate layer having a first surface which is in contact with the insulating layer and a second surface, the aggregate layer comprising at least one ceramic compound and at least one filler material; and
(c) a polymer layer formed on the second surface of the aggregate layer, the polymer layer having a first surface which is in contact with the aggregate layer and a second surface.

2. The system of claim 1, wherein the insulating layer comprises at least one material selected from aluminum silicates, ceramic insulating blankets, materials made of wool fibers from basalt rock and steel slag, or combinations of two or more thereof.

3. The system of claim 1, wherein the insulating layer has a thickness of from about 0.25 inches to about 5 inches.

4. The system of claim 3, wherein the insulating layer has a thickness of from about 1 inch to about 2 inches.

5. The system of claim 1, wherein the aggregate layer comprises an aggregate material comprising a mixture of:
(1) at least one ceramic material selected from aluminum oxide, aluminum silicates, potassium silicates, metal and non-metal nitrides, borides and carbides, or mixtures of two or more thereof;
and
(2) at least one filler material such as water glass, concrete or foamed concrete, or combinations of two or more thereof.

6. The system of claim 1, wherein the aggregate layer is acid resistant.

7. The system of claim 1, wherein the aggregate layer has a thickness in the range of about 0.75 inches to about 6 inches.

8. The system of claim 7, wherein the aggregate layer has a thickness in the range of about 1.75 inch to about 4 inches.

9. The system of claim 1, wherein the polymer layer comprises at least one fluoropolymer or epoxy-phenolic polymer, or a combination of two or more thereof.

10. The system of claim 9, wherein the polymer layer comprises at least one compound selected from tetrafluoroethylene/hexafluoropropylene copolymer, tetrafluoroethylene-perfluoroalkylvinylether copolymer, or HYFLON MFA fluoropolymer.

11. The system of claim 1, further comprising at least one support anchor.

12. The system of claim 1, further comprising a retaining member placed on the second surface of the polymer layer.

13. The system of claim 11, further comprising a retaining member placed on the second surface of the polymer layer.

14. The system of claim 1, wherein the insulating layer can withstand a temperature of at least about 200° C.

15. A system for coating a surface comprising:
(a) a ceramic layer having a first surface and a second surface, the first surface being the surface which contacts the surface to be coated;
(b) an insulating layer formed on the second surface of the ceramic layer, the insulating layer having a first surface which is in contact with the ceramic layer and a second surface;
(c) an aggregate layer formed on the second surface of the insulating layer, the aggregate layer having a first surface which is in contact with the insulating layer and a second surface, the aggregate layer comprising at least one ceramic compound and at least one filler material; and
(d) a polymer layer formed on the second surface of the aggregate layer, the polymer layer having a first surface which is in contact with the aggregate layer and a second surface.

16. The system of claim 15, wherein the ceramic layer comprises at least one compound selected from aluminum oxide, magnesium oxide, chromium oxide, silicon monoxide, silicon dioxide, titanium dioxide, metal and non-metal nitrides, borides and carbides, or mixtures of two or more thereof.

17. The system of claim 15, wherein the ceramic layer has a thickness in the range of from about 2 mils to about 10 mils.

18. The system of claim 17, wherein the ceramic layer has a thickness in the range of about 4 mils to about 6 mils.

19. The system of claim 15, wherein the ceramic layer has a porosity of less than about 1.5%.

20. The system of claim 19, wherein the ceramic layer has a porosity of less than about 0.5%.

21. The system of claim 15, wherein the insulating layer comprises at least one material selected from aluminum silicates, ceramic insulating blankets, materials made of wool fibers from basalt rock and steel slag, or combinations of two or more thereof.

22. The system of claim 15, wherein the insulating layer has a thickness of from about 0.25 inches to about 5 inches.

23. The system of claim 22, wherein the insulating layer has a thickness of from about 1 inch to about 2 inches.

24. The system of claim 15, wherein the aggregate layer comprises an aggregate material comprising a mixture of:
(1) at least one ceramic material selected from aluminum oxide, aluminum silicates, potassium silicates, metal and non-metal nitrides, borides and carbides, or mixtures of two or more thereof;
and
(2) at least one filler material such as water glass, concrete or foamed concrete, or combinations of two or more thereof.

25. The system of claim 15, wherein the aggregate layer is acid resistant.

26. The system of claim 15, wherein the aggregate layer has a thickness in the range of about 0.75 inches to about 6 inches.

27. The system of claim 26, wherein the aggregate layer has a thickness in the range of about 1.75 inches to about 4 inches.

28. The system of claim 15, wherein the polymer layer comprises at least one fluoropolymer or epoxy-phenolic polymer, or a combination of two or more thereof.

29. The system of claim 28, wherein the polymer layer comprises at least one compound selected from tetrafluoroethylene/hexafluoropropylene copolymer, tetrafluoroethylene-perfluoroalkylvinylether copolymer, or HYFLON MFA fluoropolymer.

30. The system of claim 15, further comprising at least one support anchor.

31. The system of claim 15, further comprising a retaining member placed on the second surface of the polymer layer.

32. The system of claim 30, further comprising a retaining member placed on the second surface of the polymer layer.

33. The system of claim 15, wherein the insulating layer can withstand a temperature of at least about 200° C.

34. A coated article resistant to corrosion or deterioration comprising:
(a) a substrate having an interior surface and an exterior surface;
(b) an insulating layer formed on the exterior surface of the substrate, the insulating layer having a first surface which is in contact with the exterior surface of the substrate and a second surface;
(c) an aggregate layer formed on the second surface of the insulating layer, the aggregate layer having a first surface which is in contact with the insulating layer and a second surface, the aggregate layer comprising at least one ceramic compound and at least one filler material; and
(d) a polymer layer formed on the second surface of the aggregate layer, the polymer layer having a first surface which is in contact with the aggregate layer and a second surface.

35. The article of claim 34 wherein the substrate is a pipe, flue or conduit.

36. The article of claim 34, wherein the insulating layer can withstand a temperature of at least about 200° C.

37. A coated article resistant to corrosion or deterioration comprising:
(a) a substrate having an interior surface and an exterior surface;
(b) a ceramic layer formed on the exterior surface of the substrate, the ceramic layer having a first surface which is in contact with the exterior surface of the substrate and a second surface;
(c) an insulating layer formed on the second surface of the ceramic layer, the insulating layer having a first surface which is in contact with the ceramic layer and a second surface;
(d) an aggregate layer formed on the second surface of the insulating layer, the aggregate layer having a first surface which is in contact with the insulating layer and a second surface, the aggregate layer comprising at least one ceramic compound and at least one filler material; and
(e) a polymer layer formed on the second surface of the aggregate layer, the polymer layer having a first surface which is in contact with the aggregate layer and a second surface.

38. The article of claim 37 wherein the substrate is a pipe, flue or conduit.

39. The article of claim 37, wherein the insulating layer can withstand a temperature of at least about 200° C.

40. A method for protecting a surface comprising the steps of:
(1) applying an insulating layer to at least one surface of the surface to be protected, the insulating layer having a first surface which is in contact with the at least one surface of the surface to be protected and a second surface;
(2) applying an aggregate layer to the second surface of the insulating layer, the aggregate layer having a first surface which is in contact with the insulating layer and a second surface, the aggregate layer comprising at least one ceramic compound and at least one filler material; and
(3) applying a polymer layer to the second surface of the aggregate layer, the polymer layer having a first surface which is in contact with the aggregate layer and a second surface.

41. The method of claim 40, wherein the surface to be protected is a pipe, flue or conduit.

42. The method of claim 40, wherein prior to step (1) the at least one surface of the surface to be protected is cleaned to remove any corrosion present thereon.

43. The method of claim 40, wherein prior to step (1) the at least one surface of the surface to be protected is inspected for defects, holes and/or cracks.

44. The method of claim 43, wherein prior to step (1) the at least one or more defects, holes and/or cracks are repaired.

45. The method of claim 40 wherein prior to step (1) at least one or more support anchors are attached to the at least one surface of the surface to be protected via a suitable attachment means.

46. The method of claim 40, further comprising the step of:
(4) applying a retaining member over to the second surface of the polymer layer.

47. The method of claim 40, wherein the insulating layer can withstand a temperature of at least about 200° C.

48. A method for protecting a surface comprising the steps of:
(1) applying a ceramic layer to at least one surface of the surface to be protected, the ceramic layer having a first surface which is in contact with the at least one surface of the surface to be protected and a second surface;
(2) applying an insulating layer to the second surface of the ceramic layer, the insulating layer having a first surface which is in contact with the ceramic layer and a second surface;
(3) applying an aggregate layer to the second surface of the insulating layer, the aggregate layer having a first surface which is in contact with the insulating layer and a second surface, the aggregate layer comprising at least one ceramic compound and at least one filler material; and
(4) applying a polymer layer to the second surface of the aggregate layer, the polymer layer having a first surface which is in contact with the aggregate layer and a second surface.

49. The method of claim 48, wherein the surface to be protected is a pipe, flue or conduit.

50. The method of claim 48, wherein prior to step (1) the at least one surface of the surface to be protected is cleaned to remove any corrosion present thereon.

51. The method of claim 48, wherein prior to step (1) the at least one surface of the surface to be protected is inspected for defects, holes and/or cracks.

52. The method of claim 51, wherein prior to step (1) the at least one or more defects, holes and/or cracks are repaired.

53. The method of claim 48 wherein prior to step (1) at least one or more support anchors are attached to the at least one surface of the surface to be protected via a suitable attachment means.

54. The method of claim 48, further comprising the step of:
(5) applying a retaining member over to the second surface of the polymer layer.

55. A system for coating a surface comprising:
(a) at least one inner polymer layer, each inner polymer layer having a first surface and a second surface, the first surface being the surface which contacts or faces the surface to be coated;
(b) a metal shell, the metal shell having a first surface which is in contact with the second surface of the at least one inner polymer layer and a second surface;
(c) an insulating layer formed on the second surface of the metal shell, the insulating layer having a first surface which is in contact with the second surface of the metal shell and a second surface;
and
(d) an outer polymer layer formed on the second surface of the insulating layer, the outer polymer layer having a first surface which is in contact with the insulating layer and a second surface.

56. The system of claim 55, wherein there are at least two polymer layers and wherein one or more of the at least two polymers layers is impregnated with fibers.

57. The system of claim 55, wherein the surface to be coated is a pipe, flue or conduit.

58. The system of claim 55, wherein the insulating layer can withstand a temperature of at least about 200° C.

59. A system for coating a surface comprising:
(a) a first polymer layer, the first polymer layer having a first surface and a second surface, the first surface being the surface which is in contact with the surface to be coated;
(b) a second polymer layer, the second polymer layer having a first surface which is in contact with the second surface of the first polymer layer and a second surface, the second polymer layer being impregnated with reinforcing fibers;
(c) an insulating layer formed on the second surface of the second polymer layer, the insulating layer having a first surface which is in contact with the second surface of the second polymer layer and a second surface; and
(d) a polymer layer formed on the second surface of the insulating layer, the polymer layer having a first surface which is in contact with the insulating layer and a second surface.

60. The system of claim 59, wherein the surface to be coated is a pipe, flue or conduit.

61. The system of claim 59, wherein the insulating layer can withstand a temperature of at least about 200° C.

62. A system for coating an interior surface comprising:
(a) a ceramic layer having a first surface and a second surface, the first surface being the surface which contacts the interior surface to be coated;
(b) a polymer layer formed on the second surface of the ceramic layer, the polymer layer having a first surface which is in contact with the ceramic layer and a second surface; and
(c) an aggregate layer formed on the second surface of the polymer layer, the aggregate layer having a first surface which is in contact with the polymer layer and a second surface, the aggregate layer comprising at least one ceramic compound and at least one filler material.

63. The system of claim 55, wherein the system further comprises at least one support anchor.
